(19) United States
(12) Patent Application Publication
(10) Pub. No.: US 2002/0110618 A1
(43) Pub. Date: Aug. 15, 2002

(54) Apparatus having a moving mold clamping seat for high temperature fluid injection molding

(76) Inventors: Lang-Fu Tsai, Hsinchu (TW); Hsin-Hung Lin, Taichung (TW); Yuh-Long Lin, Llan (TW); Hsuan Peng, Taipei (TW); Chi-Shien Lee, Taipei (TW); Wen-Min Hsu, Miaoli (TW); Ming-Lang Chang, Hsinchu (TW); Wann-Fu Su, Hsinchu (TW)

Correspondence Address: RABIN & BERDO, P.C., SUITE 500, 1101 14th STREET, N.W., WASHINGTON, DC, 20005, US

(21) Appl. No.: 10/134,593

(22) Filed: Apr. 30, 2002

Related U.S. Application Data
(63) Continuation-in-part of application No. 09/591,685, filed on Jun. 12, 2000.

(51) Int. Cl. B29C 45/68

(52) U.S. Cl. 425/574; 425/593; 425/451.6; 425/451.7

(57) ABSTRACT

An apparatus having a movable mold clamping seat for high temperature fluid injection molding includes a barrel supporting seat, a barrel, a injecting nozzle, a set of hydraulic cylinders, a static platen, a movable plate and a mold. The barrel supporting seat is jointed to a machine body. The barrel has one end fixed to the barrel supporting seat, and the injecting nozzle is fixed to the other end. The static platen is movable on the machine body. One end of each hydraulic cylinder is fixed to the barrel supporting seat, while the end of is fixed to the static platen. The center lines of the hydraulic cylinders are in the same plane as the center line of the barrel. By pulling the hydraulic cylinder, the injecting nozzle passes through a hole in the static platen to contact a sprue bushing for injecting a high temperature fluid into the mold.

### CROSS-REFERENCE TO RELATED APPLICATIONS

This Application is a Continuation-in-Part of application Ser. No. 09/591685, filed Jun. 12, 2000, and entitled APPARATUS HAVING A MOVING MOLD CLAMPING SEAT FOR HIGH TEMPERATURE FLUID INJECTION MOLDING.

### BACKGROUND OF THE INVENTION

1. Field of the Invention

The present invention relates to an apparatus having a moving-mold clamping seat for high temperature fluid injection molding, which has the features of a closed force path, easily being installed and adjusted, and preventing the leakage of high temperature fluid.

2. Description of the Related Art

FIG. 1 shows a prior art injection molding apparatus for high temperature fluids (for example, melted Mg, Al, Zn, or super engineering plastics). The stationary mold half of a mold 21 is locked to the static platen 20. The movable mold half thereof is locked to a movable plate 22. The movable platen 22 is slidable on four guide posts 26. When the movable platen 22, moves towards the static platen 20, the two mold halves are engaged for injection molding. The static platen 20, movable platen 22, guide posts 26, and other related units driving the movable platen 22 to slide form a mold clamping seat. One end of each of two hydraulic cylinders 24 is fixed to the machine body 30 through a hydraulic cylinder fixing seat 25, while another end thereof is fixed to the static platen 20. When the hydraulic cylinders 24 pull the static platen 20 toward the barrel supporting seat 12, the mold clamping seat moves forwards. One end of the barrel 11 is fixed to the barrel supporting seat 12, while another end has an exit element, such as an injecting nozzle 11a. A screw or a plunger 14 is installed in the barrel 11.

To inject high temperature fluid, the movable and stationary mold halves are engaged first. Then, by pulling the hydraulic cylinders 24, the mold clamping seat can be driven to move forward along the guide tracks 23 so that the injecting nozzle 11a passes through the tapered round hole of the static platen 20 so as to tightly contact with the sprue bushing of the mold 21. Then, high temperature fluid is feed into the barrel 11 through the feeding hopper 10. By moving the screw or the plunger 14 in the barrel 11, the high temperature fluid will be conveyed forwards and is uniformly mixed. After metering the amount of the material to be injected, the screw or plunger 14 is driven to cause the high temperature fluid in the barrel 11 to be injected into the mold 21 and then fully fill the mold cavity of the mold 21. After sustained pressure and cooling, the material injected forms a desired shape.

In the injection process, since the opening of the mold must tightly contact with the nozzle to prevent leakage of high temperature fluid, the pulling force from the hydraulic cylinder must satisfy the injecting nozzle contact force needed for tight contact of the sprue bushing of the mold and the injecting nozzle. For example, for a 100 ton Mg alloy injection machine, this pulling force is approximately to 9000 Kg. When the sprue bushing and the injecting nozzle are in contact, the pulling force of the hydraulic cylinder is conveyed to the mold from the static platen, and then is conveyed to the injecting nozzle, the barrel, and the barrel supporting seat, and finally is absorbed by the machine body. Moreover, when the hydraulic cylinder provides the pulling force for the contact of the injecting nozzle, the hydraulic cylinder fixing seat is subjected to a reaction force which is conveyed to the machine body. As a result, when the injection cycle is performed repeatedly, the machine body is subjected to a periodic load from the barrel supporting seat and the hydraulic cylinder. Since this force is very large, the structure of the machine body tends to deform after use for a long period of time. Therefore, the precise fit of the components assembled to the machine body cannot be sustained and thus, the machine may require shut-down for adjustment to get the required fit. Moreover, since the contact force of the injecting nozzle is applied above the barrel supporting seat, it will induce a torque at the joint of the barrel supporting seat and the machine body. The torque will cause the barrel supporting seat to deform outwards, and thus the injecting nozzle and the mold will not contact tightly. As a result, high temperature fluid will leak out so that the operator must trip down the machine for maintenance. This produces some inconvenience in operation or even some seriously dangerous condition.

### SUMMARY OF THE INVENTION

Accordingly, the primary object of the present invention is to provide an apparatus having a moving mold clamping seat for high temperature fluid injection molding, wherein a close force path is formed, so that no periodic load is applied to the machine body, and thus machine alignment will not degrade due to deformation of machine body. Moreover, a hydraulic cylinder fixing seat is not used, and thus the number of machine elements is reduced. The assembly work can be performed easily and a high precision in assembly can be sustained. Furthermore, injecting nozzle contact force and the reaction force of the pulling force are in the same plane, thus, the injecting nozzle and the mold can be kept in contact tightly. Therefore, leaking of high temperature fluid out the injecting nozzle can be prevented so as to avoid a dangerous condition.

In order to achieve the aforesaid objects, the present invention provides an apparatus having a moving mold clamping seat for high temperature fluid injection molding. The apparatus having a moving mold clamping seat for high temperature fluid injection molding comprises a barrel supporting seat, a barrel, a injecting nozzle, a set of hydraulic cylinders, a static platen, a movable plate and a mold. The barrel supporting seat is jointed to a machine body. The barrel has one end fixed to the barrel supporting seat. The injecting nozzle is fixed to another end of the barrel. The injecting nozzle passes through the static platen to contact a sprue bushing of the mold. The mold has a mold cavity and a sprue bushing, and by this mold cavity, the high temperature fluid is formed with a desired shape. One end of each hydraulic cylinder is fixed to the barrel supporting seat, while another end of the hydraulic cylinders is fixed to the static platen. The center lines of the hydraulic cylinders are in the same plane as the center line of the barrel. A tapered round hole is formed at a center of the static platen. One side of the static platen is locked to the mold. By pulling the hydraulic cylinder, the injecting nozzle is caused to pass through the tapered round hold of the static platen to contact with the sprue bushing of the mold. By fixing the hydraulic cylinder directly to the barrel supporting seat, the center lines of the barrel and the pair of hydraulic cylinders can all be positioned in the same plane. The pulling force of the hydraulic cylinders will be conveyed to the static platen, mold, injecting nozzle, barrel, barrel supporting seat and back to the hydraulic cylinder. Thus, a close force transferring path is formed without passing through the machine body. Therefore, no periodic load is applied to the machine body, and thus machine alignment is preserved. Furthermore, since all forces are in the same plane, the injecting nozzle and the sprue bushing of the mold can contact with one another tightly. Therefore, high temperature fluid will not leak out to produce a dangerous condition.

The various objects and advantages of the present invention will be more readily understood from the following detailed description when read in conjunction with the appended drawing.

### BRIEF DESCRIPTION OF THE DRAWINGS

FIG. 1 is a perspective view of a prior art apparatus having a movable mold clamping seat.

FIG. 2 is a perspective view of the apparatus having a movable mold clamping seat according to the present invention.

FIG. 3 shows the force path of the apparatus having a movable mold clamping seat for high temperature fluid injection molding according to the present invention.

FIG. 4 is a cross-sectional view of the apparatus a movable mold clamping seat with a toggle mechanism and a transmission mechanism.

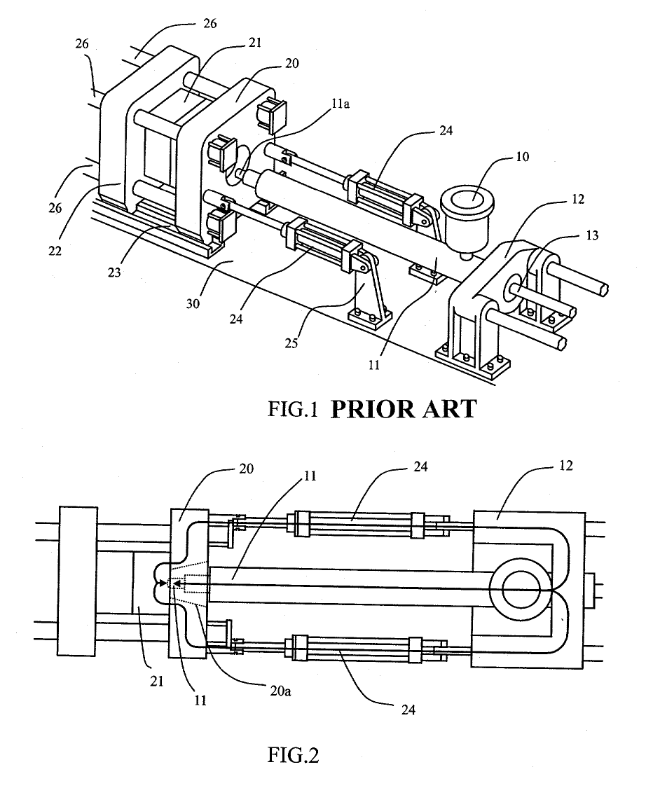

### DETAILED DESCRIPTION OF THE PREFERRED EMBODIMENTS

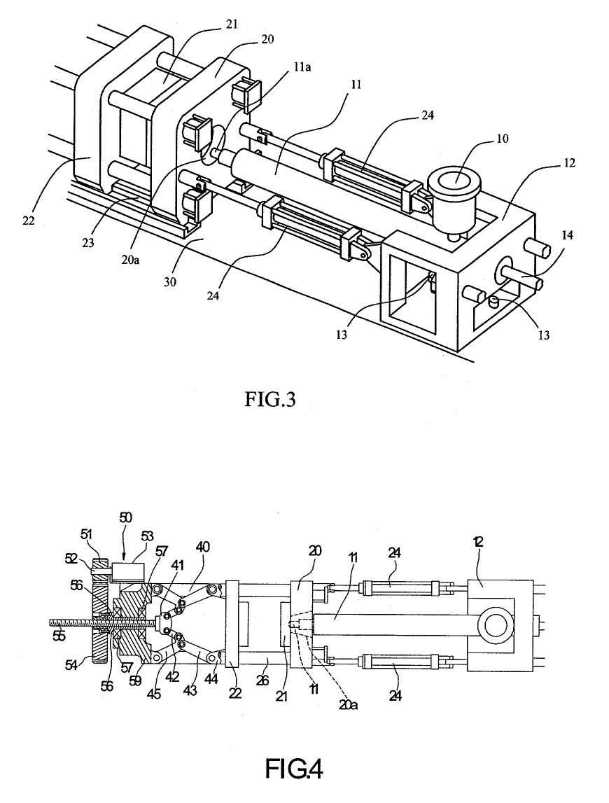

With reference to FIGS. 2 and 3, an apparatus having a movable mold clamping seat for high temperature fluid injection molding, according to the present invention, is illustrated herein. The apparatus having a movable mold clamping seat for high temperature fluid injection molding includes a barrel supporting seat 12, a barrel 11, an injecting nozzle 11a, a pair of hydraulic cylinders 24, a static platen 20, a movable platen 22 and a mold 21.

The barrel supporting seat 12 is jointed to the machine body 30 by a fixing screw 13. The barrel 11 includes a screw or plunger 14 which can be driven for rotation and for translation. A material feeding hopper 10 is installed in the barrel 11, which serves to feed high temperature fluid into the barrel 11. One end of the barrel 11 is fixed to the barrel supporting seat 12. Another end of the barrel 12 is fixed with the injecting nozzle 11a. One end of each hydraulic cylinder 24 is fixed to the barrel supporting seat 12, while another end thereof is fixed to the static platen 20. The static platen 20 and the movable platen 22 form a mold clamping seat. The two mold halves of the mold 21 are fixed to the static platen 20 and the movable platen 22, respectively. The center lines of the hydraulic cylinders 24 are parallel to and in the same plane with the center lines of the barrel 11. The center of the static platen 20 has a tapered round hole 20a. By pulling of the hydraulic cylinders 24, the mold clamping seat can be driven to move forwards along the guide tracks 23 fixed to the machine body 30. Meanwhile, the injecting nozzle 11a can pass through the tapered round hole 20a of the static platen 20 to contact the sprue bushing of the mold 21. Then, high temperature fluid is fed into the barrel 11 through the material feeding hopper 10. By moving the screw rod or the plunger 14 in the barrel 11, the high temperature fluid will be conveyed forwards and uniformly mixed after metering the amount of the material to be injected. The screw or plunger is driven to cause the high temperature fluid in the barrel 11 to be injected into the mold 21 and then fully fill the mold cavity of the mold 21. After sustained pressure and cooling, the material injected forms a desired shape.

As shown in FIG. 3, By fixing the hydraulic cylinder 24 directly to the barrel supporting seat 12, the force path of the movable apparatus comprising a mold clamping seat having a mold 21, a static platen 20, a nozzle 11a, a barrel 11, a barrel supporting seat 12 and a pair of hydraulic cylinders 24 lies in a common plane. The pulling and pushing forces of the hydraulic cylinders 24 will be conveyed from the static platen 20, mold 21, nozzle 11a, barrel 11, and barrel supporting seat 12, to the hydraulic cylinder 24. Thus, a force path is formed without passing through the machine body 30.

Please refer to FIG. 4, the present invention further comprises, a toggle mechanism 40 including a fixing seat 59, a pair of connected arms 45 each having one end arranged on the fixing seat 59, a pair of connected rods 42 each pivotally connected to an upper part of the other end of each of the connected arms 45, a connected block 41 pivotally connected to one end of each of the connected rods 42, a pair of linked rods 43 each having one end pivotally connected to an lower part of the other end of each of the connected arms 45 and the other end pivotally connected to each of a pair of pillars 44 which are coupled on said movable platen 22; and a transmission mechanism 50 including a servo motor 53 with a rotated shaft 52, a small gear 51 having a center hole fixedly arranged to the rotated shaft 52 of the servo motor 53 so as to drive said small gear 51 to rotate, a large gear 54 being engaged to said small gear 51, a nut 56 having a side tightly fixed on a side of the large gear 54 so that the nut 56 and the large gear 54 can be rotated together, a screw 55 having a distal end coupled to said connected block 41 and being passed through a center hole of the large gear 54 and being engaged with an inside thread of the nut 56, and two bearings 57 disposed on said fixing seat 59 and can support said the nut 56 to rotate.

In operation, when the servo motor 53 is rotated, the small gear 54 is rotated through the rotated shaft 52, the large gear 51 meshed with the small gear 54 and then the nut 56 fixed to the large gear 51 so as to be rotated. Further, when the nut 56 is rotated, the screw 55 meshed with the nut 56, so that the screw 55 can be shifted to the right and left, in this manner, the rotational motion of the servo motor 53 is converted to a linear motion of the screw 55, thereby to be able to drive the connected block 41 which is fixed to the distal end to tug said toggle mechanism 40 for transmitting power from the servo motor 53 to said toggle mechanism 40. Therefore, said toggle mechanism 40 can drive the move platen 22 to slide backward and forward along the guide posts 26, so as to achieve the open or close action of the mold 21.

The present invention has a closed force path, and therefore, its embodiment has the following features:

1. No periodic load is applied to the machine body, and thus machine alignment will not degrade due to deformation of the machine body.

2. A hydraulic cylinder fixing seat is not used, and thus the required number of element is reduced. The assembly work can be performed easily and a high precision in assembly can be maintained.

3. All the loads are positioned in the same plane. In the process of injection molding, the sprue bushing of the mold and the injecting nozzle contact with one another tightly.

Therefore, high temperature fluid will not leak out so as to produce a dangerous condition.

Although the present invention has been described with reference to the preferred embodiments, it will be understood that the invention is not limited to the described details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus having a movable mold clamping seat for high temperature fluid injection molding comprising:
a barrel supporting seat fixedly joined to a machine body;
a barrel having an end fixed to the barrel supporting seat;
a injecting nozzle fixed to another end of the barrel;
a mold clamping seat including a movable platen and a static platen configured to clamp together movable and static halves of a mold to form a mold cavity, the mold having a sprue bushing through which high temperature fluid can be injected into the mold cavity;
a set of hydraulic cylinders configured to move the mold clamping seat so as to cause the injecting nozzle to contact with the sprue bushing of the mold, each of the hydraulic cylinders being fixed to the barrel supporting seat at one end thereof and being fixed to the static platen at the other end thereof; and center lines of the hydraulic cylinders being in the same plane as a center line of the barrel; and
a toggle mechanism including a fixing seat, a pair of connected arms each having one end arranged on the fixing seat, a pair of connected rods each pivotally connected to an upper part of the other end of each of the connected arms, a connected block pivotally connected to one end of each of the connected rods, a pair of linked rods each having one end pivotally connected to an lower part of the other end of each of the connected arms and the other end pivotally connected to each of a pair of pillars coupled on said movable platen; and
a transmission mechanism including a servo motor with a rotated shaft, a small gear having a center hole fixedly arranged to the rotated shaft of the servo motor so as to drive said small gear to rotate, a large gear being engaged with said small gear, a nut having a side tightly fixed on a side of the large gear so that the nut and the large gear can be rotated together, a screw having a distal end coupled to said connected block and being passed through a center hole of the large gear and being engaged with an inside thread of the nut, and two bearings disposed on said fixing seat so as to support said the nut to rotate.

2. The apparatus as claimed in claim 1, wherein a tapered round hole, through which the injecting nozzle passes to contact with the sprue bushing of the mold, is formed at a center of the static platen.

3. The apparatus as claimed in claim 1, wherein guide tracks are fixed to the machine body, and the mold clamping seat is movable along the tracks.

4. The apparatus as claimed in claim 1, wherein the static mold half is fixed to the static platen and the movable mold half is fixed to the movable platen.

5. The apparatus as claimed in claim 1, wherein one of a rotatable screw and a plunger is disposed in the barrel.

6. The apparatus as claimed in claim 1, wherein a material feeding hopper is disposed in the barrel for transferring high temperature fluid into the barrel.
